(19) United States
(12) Patent Application Publication
(10) Pub. No.: US 2007/0039198 A1
(43) Pub. Date: Feb. 22, 2007

(54) Method for drying laundry and laundry dryer for carrying out said method

(75) Inventors: Hans-Werner Boettcher, Lehrte (DE); Eckhard Nave, Lehrte (DE); Holger Wagner, Hannover (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Miele & Cie, KG, Gutersloh (DE)

(21) Appl. No.: 10/576,455

(22) PCT Filed: Oct. 20, 2004
(86) PCT No.: PCT/EP04/11856

§ 371 Date: Apr. 20, 2006

(30) Foreign Application Priority Data
Oct. 23, 2003 (DE) 103 49 712.9

(51) Int. Cl. F26B 11/02; F26B 21/06

(52) U.S. Cl. 34/131; 34/558

(57) ABSTRACT

A method for drying laundry in a laundry dryer having a program control device, a drying chamber and a process air circuit includes providing a flow dividing device in the process air circuit for dividing the drying air flow into an exhaust air component and a recirculated air component. A sensor is used to measure a pressure in the process air stream in an area where the drying air enters the drying chamber. The pressure is evaluated and the flow dividing device is controlled based on the evaluation so as to reduce or set to zero the recirculated air component and to continue the drying process at a reduced volumetric flow rate of the drying air through the drying chamber.

The present invention relates to a method for drying laundry and to a laundry dryer for carrying out said method, including a drying chamber and a process air circuit in which are disposed a heater and a blower for conveying the drying air through the drying chamber; the process air circuit including a fresh air supply passageway and an exhaust air discharge passageway and having disposed therein means for dividing the drying air flow into an exhaust air component and a recirculated air component; the laundry dryer having sensors for measuring process parameters; and the means for dividing the drying air flow being controlled to modify the exhaust air/recirculated air ratio according to the measured parameters.

Such a method is described in German Patent Application DE 22 20 425 A1 for a laundry dryer having a water-cooled condenser. In that method, the drying air is conveyed through the process air duct containing the blower, the heater and the water-cooled condenser, and through the drying chamber. The process air duct is provided with a fresh air supply passageway and an exhaust air discharge passageway. Means for dividing the drying air flow into an exhaust air component and a recirculated air component are provided by dampers disposed in the process air duct, said dampers completely or partially opening or closing the fresh air port and the exhaust air port. In a first drying cycle, in which the laundry is still wet or relatively damp, the drying air is circulated in a closed circuit. In this first drying cycle, the dampers are closed. In the further drying process, after the laundry reaches a predetermined degree of dryness, the laundry dryer can be operated in a mode in which the circuit is partially open. In the process, part of the drying air is returned to the drying chamber as a recirculated air component and part of it is removed from the appliance as an exhaust air component. The residual moisture content in the laundry is evaluated as a process parameter for controlling the dampers. In this drying cycle, the water-cooled condenser remains on, and the dampers partially open to let in fresh air and discharge exhaust air, respectively. When the laundry has reached a higher degree of dryness, the condenser is turned off and the laundry dryer is operated as an air-vented dryer with the fresh air supply passageway and the exhaust air port open.

German document DE 200 10 728 U1 describes a laundry dryer having a recirculating air system, where the heater, the blower and a recirculating air box provided with a controllable damper for adjusting the exhaust air/recirculated air ratio of the drying air are combined into one unit and disposed on top of the laundry dryer. In that laundry dryer, the exhaust air/recirculated air mode, i.e., the position of the damper for the exhaust air/recirculated air ratio, must be selected manually. No provision is made for the damper to be controlled according to process parameters.

Also known is a laundry dryer (Miele T 6251) which features a fixed routing of the exhaust air/recirculated air and in which part of the drying air is returned to the drying chamber as a recirculated air component during the entire drying process. The drying chamber of this laundry dryer is provided by a rotatably supported drying drum having a capacity of 250 liters. Downstream of the drying drum is a process air circuit portion which contains a filter device and is referred to as filter chamber. The blower area containing the blower is located downstream of the filter chamber. On the pressure side of the blower, a baffle plate is arranged in the direction of flow, said baffle dividing the air flow into the exhaust air component and the recirculated air component. The exhaust air component is removed from the appliance through the exhaust air port. The recirculated air component is mixed with fresh air, which is drawn in through the fresh air port because of the negative pressure in the drying drum. The fresh air component und recirculated air component are reheated by the heater and returned to the drying drum. At the beginning of the drying process, the still wet and heavy laundry is moved in the air stream inside the drying drum in an optimum manner. Toward the end of the drying process, the laundry almost completely fills the drying drum. Due to the arrangement, design and rating of the blower for a large-capacity drying drum, the laundry items may be drawn to the air outlet of the drying drum. When drying duvets, pillows and down blankets, the laundry may be drawn onto the drying air outlet of the drying drum by the negative pressure when the laundry load has reached a higher degree of dryness. This problem may also occur when drying airtight textiles, such as outdoor clothing. The textiles adhering to the suction port interrupt the passage of air through the drying drum, and the laundry in the drum is overheated, i.e., not dried in a gentle manner.

It is, therefore, an object of the present invention to prevent laundry damage from occurring if the drying air flow in the drying drum is interrupted and to obtain an optimum drying result.

This object is achieved in accordance with the present invention by a method having the features set forth claim 1 and by a laundry dryer for carrying out the method, having the features set forth in claim 3. Advantageous embodiments and refinements of the present invention will become apparent from the respective following dependent claims.

One particular advantage that can be achieved with the present invention is that an interruption of the drying air flow caused by textiles partially or completely blocking the path of the air can be detected by directly monitoring the pressure conditions or the pressure profile in the drying chamber. Depending on the measured values, the recirculated air component of the drying air is reduced or set to zero, and the drying process is continued at a reduced volumetric flow rate. This reduces the suction effect on the textiles, and the path of the air is cleared. In an advantageous refinement of the method according to the present invention, the heating power is reduced or turned off according to the reduced volumetric flow rate through the drying drum.

Another particular advantage that can be achieved with the present invention is that the pressure sensor is directly associated with the drying chamber. Advantageously, the pressure sensor is disposed in the area of the air inlet opening to the drying chamber, which makes it possible to react immediately to the pressure conditions prevailing in the drying chamber. Depending on the measured pressure value, the volumetric flow of drying air in the drying chamber is reduced by actuating a shut-off damper disposed in the process air circuit for the recirculated air path of the recirculated air component in the drying air. The recirculated air path may be completely or partially closed. In this manner, the suction effect on the textiles adhering to the suction port, that is, to the air outlet opening, is reduced, and the textiles fall back into the drying chamber. It has proven advantageous if the drying process is then continued at the reduced volumetric flow of the drying air in order to prevent the drying air flow from being interrupted by the textiles again. Depending on the reduced volumetric flow rate, it is advantageous that the heating power be also reduced or completely turned off.

An exemplary embodiment of the present invention is shown in the drawings in a purely schematic way and will be described in more detail below. In the drawings,

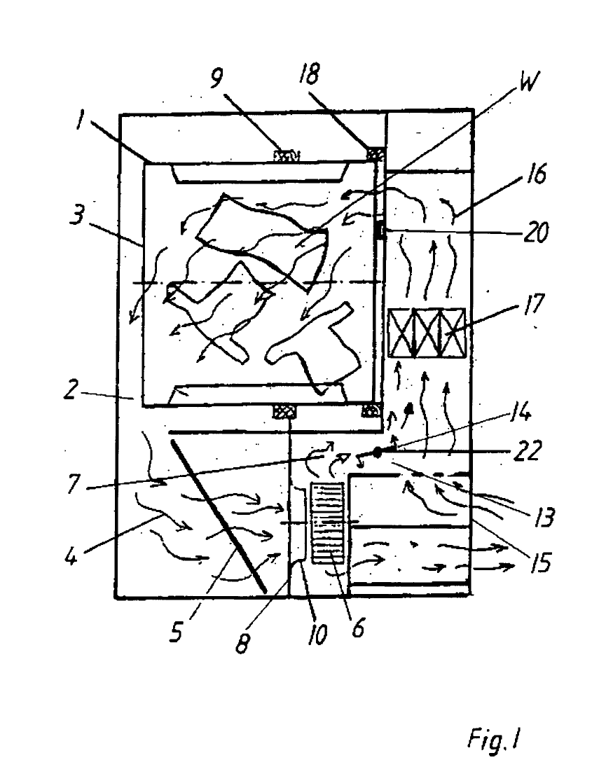

FIG. 1 is a schematic cross-sectional side view of an inventive laundry dryer for carrying out the method;

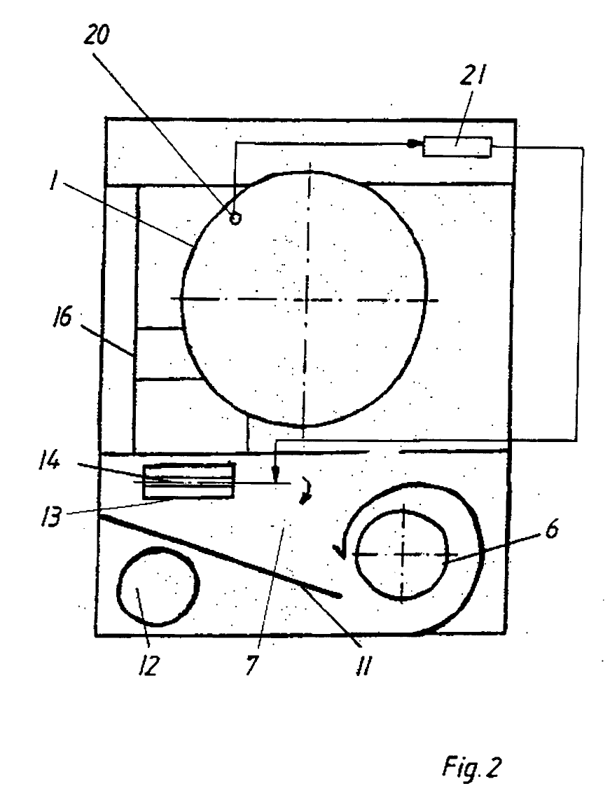

FIG. 2 is a schematic front view of the exhaust air/recirculated air separation system;

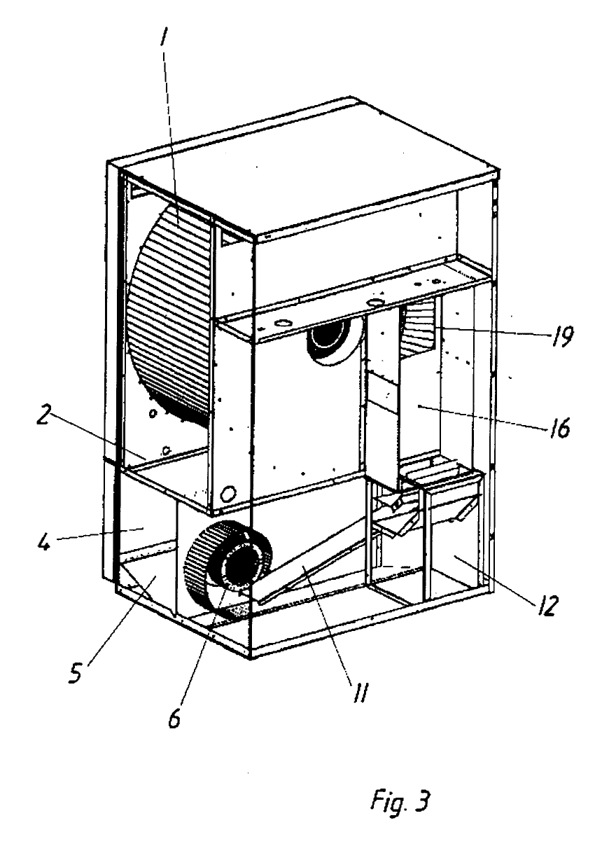

FIG. 3 is a perspective view of the laundry dryer showing the arrangement of the shut-off damper for the recirculated air path.

In FIG. 1, the drying chamber of a laundry dryer takes the form of a rotatably supported drying drum (1). Air outlet opening (2) of drying drum (1) is located in the area of the front-loading opening (3) for the laundry and is connected to a downstream process air circuit portion which contains a filter device (5) and can be referred to as filter chamber (4). A blower (6) conveys the drying air from filter chamber (4) through filter device (5) and to blower area (7), which contains the exhaust air/recirculated air distribution system. Said blower area (7) containing the exhaust air/recirculated air distribution system is sealed from filter chamber (4) by a partition (8) having a sealing arrangement (9) which faces toward rotating drying drum (1). The drying air is conveyed to the blower (6) in an axial direction through an inlet nozzle (10) formed in partition (8).

FIG. 2 is a schematic front view of blower area (7) showing the means (baffle plate 11, damper 14) for dividing the drying air flow into an exhaust air component and a recirculated air component. Baffle plate (11), which divides the radially exiting air flow into the exhaust air component and the recirculated air component, is arranged on the pressure side of blower (6) and nearly parallel to the direction of flow of the exiting drying air. The exhaust air component is removed from the appliance through the exhaust air port (12). The recirculated air component is conveyed to recirculated air path (13), which can be completely or partially closed by a damper (14), which is shown in greater detail in FIG. 1. The recirculated air component is mixed with fresh air, which is drawn in through the fresh air port (15) at the rear of the appliance because of the negative pressure in drying drum (1). The fresh air component und recirculated air component are reheated by heater (17) disposed in heating duct section (16) of the drying air circuit, and returned to drying drum (1). An additional sealing arrangement (18) is disposed between heating duct section (16) and rotating drying drum (1). A pressure sensor (20) measuring the pressure profile in drying drum (1) is located in the space between stationary heating duct section (16) and rotating drying drum (1) in the area (19) where the drying air enters drying drum (1). The pressure profile is evaluated by program control module (21) of the laundry dryer for purposes of controlling the damper (14) disposed in recirculated air path (13). If, in the course of the drying process, laundry items (W) are drawn to air outlet (2) of drying drum (1), the drying air flow in drying drum (1) is interrupted. Damper (14) disposed in recirculated air path (13) is activated according to the deviation from the acceptable pressure value or pressure profile in drying drum (1). In the process, the recirculated air component of the drying air is reduced or set to zero by fully or partially closing damper (14) using an actuator device (22). The drying process is continued at a reduced volumetric flow rate through drying drum (1). When damper (14) is fully closed, the volumetric flow rate of the drying air is reduced to the fixed amount of exhaust air volume flow, which is determined by the arrangement of baffle plate (11). The heating power can be reduced or completely turned off according to the reduced volumetric flow rate of the drying air.

FIG. 3 is a perspective view of the design of the laundry dryer, showing the essential details of the present invention, which are described in FIGS. 1 and 2.

1-5. (canceled)

6. A method for drying laundry in a laundry dryer having a program control device, a drying chamber and a process air circuit including a fresh air supply passageway and an exhaust air discharge passageway, the process air circuit having disposed therein a heater and a blower for conveying drying air through the drying chamber, the method comprising:
providing a flow dividing device in the process air circuit configured to divide, into an exhaust air component and a recirculated air component, a flow of the drying air;
measuring, by a sensor, at least one of a pressure and a pressure profile in an air stream of the process air circuit in an area where the drying air enters the drying chamber;
evaluating the at least one of the pressure and the pressure profile; and
controlling the flow dividing device based on the evaluating so as to reduce or set to zero the recirculated air component and to continue a drying process at a reduced volumetric flow rate of the drying air through the drying chamber.

7. The method for drying laundry as recited in claim 1 further comprising reducing a heating power based on the reduced volumetric flow rate of the drying air.

8. A laundry dryer comprising:
a program control module;
a drying chamber;
a process air circuit including a fresh air supply passageway and an exhaust air discharge passageway;
a heater disposed in the process air circuit;
a blower disposed in the process air circuit and configured to convey drying air through the drying chamber;
a pressure sensor disposed in an area where the drying air enters the drying chamber and configured to measure at least one of a pressure and a pressure profile in the drying chamber; and
a flow dividing device disposed in the process air circuit and configured to controllably divide a flow of the drying air into an exhaust air component and a recirculated air component, the flow dividing device including a shut-off damper configured to completely or partially close an air path of the recirculated air component based on the measured at least one of a pressure and a pressure profile.

9. The laundry dryer as recited in claim 8 wherein:
the drying chamber includes a rotating drum;
the process air circuit includes a stationary heating duct section; and
the pressure sensor is disposed in a space between the stationary heating duct section and the rotating drum.

10. The laundry dryer as recited in claim 9 wherein the pressure sensor is disposed in an area where the drying air enters the drying chamber.
